(19) United States
(12) Patent Application Publication
(10) Pub. No.: US 2026/0236455 A1
(43) Pub. Date: Aug. 13, 2026

(54) PROCESS CYCLE TIME DETERMINATION METHOD AND APPARATUS, COMPUTER DEVICE AND STORAGE MEDIUM

(71) Applicant: GUANGZHOU MINO EQUIPMENT CO., LTD., Guangzhou (CN)

(72) Inventors: Weibing YAO, Guangzhou (CN); Yi HE, Guangzhou (CN); Yanzhong ZHANG, Guangzhou (CN); Zhijun ZUO, Guangzhou (CN); Kai ZHANG, Guangzhou (CN); Che WU, Guangzhou (CN); Junxiong LIU, Guangzhou (CN)

(73) Assignee: GUANGZHOU MINO EQUIPMENT CO., LTD., Guangzhou (CN)

(21) Appl. No.: 19/645,058

(22) Filed: Apr. 10, 2026

Related U.S. Application Data
(63) Continuation-in-part of application No. PCT/CN2023/143580, filed on Dec. 29, 2023.

(30) Foreign Application Priority Data
Oct. 13, 2023 (CN) 202311325465.X

(51) Int. Cl. G06F 16/23; G06F 18/2413; G06N 20/20

(52) U.S. Cl. CPC G06F 16/2365; G06F 18/24147; G06N 20/20

(57) ABSTRACT

A process cycle time determination method includes: performing processing to obtain a first dataset based on production process data and attribute data of a line body of a production line; performing two-dimensional matrix conversion on the first dataset to obtain a first matrix when there is a missing value in the first dataset; performing filling on the missing value in the first matrix by using the K-nearest neighbors model and the chain equation model of random forest to obtain a corresponding filling value; filling the filling value in the position of the corresponding missing value in the first dataset to obtain a second dataset; and determining a process cycle time of the target station of the target line body in the production process of the target vehicle type based on the second dataset.

### CROSS-REFERENCE TO RELATED APPLICATIONS

The present application is a continuation-in-part application of International Application No. PCT/CN2023/143580, filed on Dec. 29, 2023, which claims priority to the Chinese Patent Application No. 202311325465.X, filed on Oct. 13, 2023, entitled “PROCESS CYCLE TIME DETERMINATION METHOD AND APPARATUS, COMPUTER DEVICE AND STORAGE MEDIUM”. All of the aforementioned applications are incorporated herein by reference in their entireties.

### TECHNICAL FIELD

The present application relates to the technology field of industrial production line control, and in particular, to a process cycle time determination method and apparatus, a computer device and a storage medium.

### BACKGROUND

With the acceleration of flexible manufacturing industrialization process, modern measurement technologies, intelligent sensor technologies and information technologies have been widely applied to industries such as automobile manufacturing and the like, and a large amount of process data has been accumulated during the production process. However, during an actual data collection and transmission process, data missing occurs at some time points, especially when key action data of a station is missing, which will cause a certain error in a calculation of process cycle time.

At present, there are many calculation methods of process cycle time. However, they unable to provide accurate processing of missing data, such as a duration of the last action performed at the station is missing, the start time of action execution is missing, etc., resulting in a limitation in the accuracy of process cycle time determination.

### SUMMARY

Based on this, focus on the above technical problems, it is necessary to provide a process cycle time determination method and apparatus, a computer device and a storage medium capable of filling a missing data to improve the accuracy of process cycle time.

In a first aspect, the present application provides a process cycle time determination method, including:
performing processing to obtain a first dataset based on production process data and attribute data of a line body of a production line, where the first dataset includes a duration of each action performed at a target station of a target line body in a production process of a target vehicle type with respect to the first action;
performing two-dimensional matrix conversion on the first dataset to obtain a first matrix when there is a missing value in the first dataset;
performing filling on the missing value in the first matrix by using the K-nearest neighbors model and the chain equation model of random forest to obtain a corresponding filling value;
filling the filling value in the position of the corresponding missing value in the first dataset to obtain a second dataset; and
determining a process cycle time of the target station of the target line body and in the production process of the target vehicle type based on the second dataset.

In one of the embodiments, the performing filling on the missing value in the first matrix by using the K-nearest neighbors model and the chain equation model of random forest to obtain a corresponding filling value includes:
performing filling on the missing value in the first matrix by using the K-nearest neighbors model to obtain a second matrix;
performing filling on the missing value in the first matrix by using the chain equation model of random forest to obtain a third matrix; and
obtaining a filling value corresponding to the missing value in the first matrix based on the filling value filled in the position of the missing value in the second matrix and the filling value filled in the position of the missing value in the third matrix.

In one of the embodiments, the obtaining a filling value corresponding to the missing value in the first matrix based on the filling value filled in the position of the missing value in the second matrix and the filling value filled in the position of the missing value in the third matrix includes:
performing weighted summation on the filling value filled in the position of the missing value in the second matrix and the filling value filled in the position of the missing value in the third matrix to obtain the filling value corresponding to the missing value in the first matrix.

In one of the embodiments, the performing processing to obtain a first dataset based on production process data and attribute data of a line body of a production line includes:
obtaining the production process data of the production line and the attribute data of the line body of the production line, where the production process data includes a production vehicle type, a line body unique identifier code, a station unique identifier code, an action group unique identifier code, an action unique identifier code and action time information, and the attribute data of the line body of the production line includes the line body unique identifier code of the line body of the production line, the station unique identifier code, the action group unique identifier code and the action unique identifier code of the production line;
based on line body information of the production process data and the line body unique identifier code, the station unique identifier code, the action group unique identifier code and the action unique identifier code of the attribute data of the line body of the production line, associating the production process data with the attribute data of the line body of the production line to obtain a third dataset, where the third dataset includes a duration of each action performed at each station of each line body in the production process of each vehicle type with respect to the start time; and
extracting, from the third dataset, a duration of each action performed at the target station target of the line body in the production process of the target vehicle type with respect to the first action, to obtain the first dataset.

In one of the embodiments, the attribute data of the line body of the production line further includes a line body serial number, a station serial number, an action group serial number and an action serial number,
the obtaining attribute data of the line body of the production line body includes:
obtaining an intrinsic attribute data of the line body of the production line, where the intrinsic attribute data of the line body of the production line includes the line body serial number, the line body unique identifier code, the station serial number, the station unique identifier code, the action group unique identifier code, an action original serial number and the action unique identifier code;
grouping the intrinsic attribute data of the line body of the production line according to the line body serial number and the station serial number, and performing sorting for the intrinsic attribute data of the line body of the production line based on the action group serial number and the action original serial number of each station; and
generating the action serial number based on an order of sorted actions, and constructing a mapping table between different stations of line bodies of different production lines and each action performed at different stations to obtain the attribute data of the line body of the production line.

In one of the embodiments, the process cycle time includes a station actual cycle time of the target station, a station production cycle time of the target station, the start time of each action, the end time of each action and a duration of each action, where the station actual cycle time is the maximum duration of the last action of the target station with respect to the first action of the target station, and the station production cycle time is a difference between the start time of the first action of the target station and the start time of the first action of next station.

In a second aspect, the present application also provides a process cycle time determination apparatus, where the apparatus includes:
a first dataset obtaining module, configured to perform processing to obtain a first dataset based on production process data and attribute data of a line body of a production line, where the first dataset includes a duration of each action performed at a target station of a target line body in a production process of a target vehicle type with respect to the first action;
a first matrix obtaining module, configured to perform two-dimensional matrix conversion on the first dataset to obtain a first matrix when there is a missing value in the first dataset;
a filling value determining module, configured to perform filling on the missing value in the first matrix by using the K-nearest neighbors model and the chain equation model of random forest to obtain a corresponding filling value;
a second dataset generation module, configured to fill the filling value in the position of the corresponding missing value in the first dataset to obtain a second dataset; and
a process cycle time determining module, configured to determine a process cycle time of the target station of the target line body in the production process of the target vehicle type based on the second dataset.

In a third aspect, the present application also provides a computer device. The computer device includes a memory and a processor, where the memory stores a computer program, and the processor implements the steps of the above method when executing the computer program.

In a fourth aspect, the present application also provides a computer-readable storage medium. The computer-readable storage medium, on which a computer program is stored, where the computer program implements the steps of the above method when executed by a processor.

In a fifth aspect, the present application also provides a computer program product. The computer program product includes a computer program, where the computer program implements the steps of the above method when executed by a processor.

The above process cycle time determination method and apparatus, a computer device, a storage medium and a computer program product. The method includes: performing processing to obtain a first dataset based on production process data and attribute data of a line body of a production line, where the first dataset includes a duration of each action performed at a target station of a target line body in a production process of a target vehicle type with respect to the first action; when there is a missing value in the first dataset, performing two-dimensional matrix conversion on the first dataset to obtain a first matrix; using a K-nearest neighbors model and a chain equation model of random forest to perform filling on the missing value in the first matrix to obtain a corresponding filling value; filling the filling value in the position of the corresponding missing value in first dataset to obtain a second dataset; and determining a process cycle time of the target station of the target line body and in the production process of the target vehicle type based on the second dataset. By integrating the production process data with the attribute data of the line body of the production line, a time-series dataset of each action of different stations of different line bodies is constructed to provide support for subsequent missing data filling, so that the missing value can be better filled, thereby improving the accuracy of process cycle time calculation results.

### BRIEF DESCRIPTION OF THE DRAWINGS

FIG. 1 is a flowchart of a process cycle time determination method according to an embodiment.

FIG. 2 is a schematic diagram of a mapping table of each action performed at different stations of line body serial number 1 according to an embodiment.

FIG. 3 is a flowchart of using a K-nearest neighbors model and a chain equation model of random forest to perform filling on the missing value in the first matrix to obtain a corresponding filling value according to an embodiment.

FIG. 4 is a flowchart of performing processing to obtain a first dataset based on production process data and attribute data of a line body of a production line according to an embodiment.

FIG. 5 is a flowchart of obtaining attribute data of a line body of a production line according to an embodiment.

FIG. 6 is a schematic diagram of partial data of a duration (milliseconds) of each action of line body serial number 1 of station serial number 1 with respect to the first action in a production of vehicle type number 100 according to an embodiment.

FIG. 7 is a flowchart of a process cycle time determination method according to another embodiment.

FIG. 8 is a schematic structural diagram of a process cycle time determination apparatus according to an embodiment.

FIG. 9 is a diagram of an internal structure of a computer device according to an embodiment.

### DETAILED DESCRIPTION OF THE EMBODIMENTS

In order to make objectives, technical solutions and advantages of the present application clearer, the following provides a more detailed explanation of the present application with reference to the accompanying drawings and embodiments. It should be understood that the specific embodiments described here are merely used to explain the present application and are not intended to limit the present application.

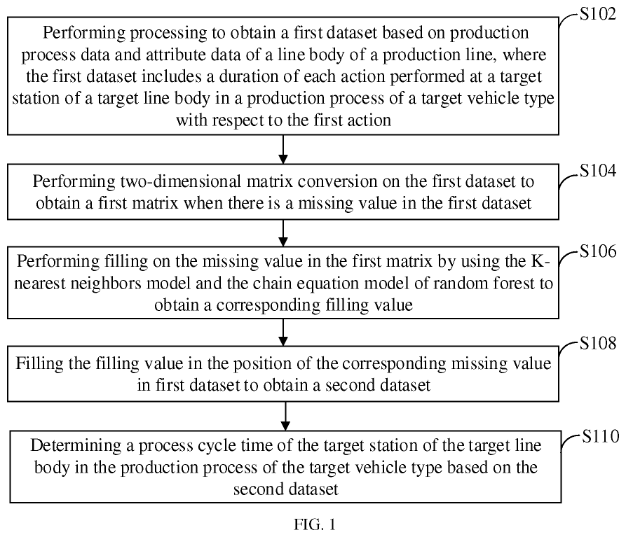

In an embodiment, as shown in FIG. 1, a process cycle time determination method is provided, and the embodiment is exemplified by applying the method to a terminal. It should be understood that the method may also be applied to a server, and may also be applied to a system including the terminal and the server, and implemented through an interaction of the terminal and the server. In this embodiment, the method includes the following steps:

S102, performing processing to obtain a first dataset based on production process data and attribute data of a line body of a production line, where the first dataset includes a duration of each action performed at a target station of a target line body in a production process of a target vehicle type with respect to the first action.

Specifically, the production process data may be acquired from data generated by the line body of the production line in the production process, or may also be obtained through further processing of data acquired from the production line. For example, one or more of the target vehicle type produced through the production line, a line body unique identifier code, a station unique identifier code, an action unique identifier code, a flag of the first action of the station, the start time of the action, the end time of the action and a duration of the action, etc.

The attribute data of the line body of the production line may be original attribute data, such as intrinsic attribute data of the line body of the production line and manual configuration data, or may also be data obtained after further processing of the original attribute data. For example, one or more of a line body serial number, the line body unique identifier code, a station serial number, the station unique identifier code, an action group serial number, an action group unique identifier code, an action serial number, the action unique identifier code, etc.

Determining the target line body, the target station and the target vehicle type based on a process cycle time to be determined, and then performing processing to obtain the first dataset based on the production process data and the attribute data of the line body of the production line, where the first dataset includes a duration of each action performed at the target station of the target line body in the production process of the target vehicle type with respect to the first action.

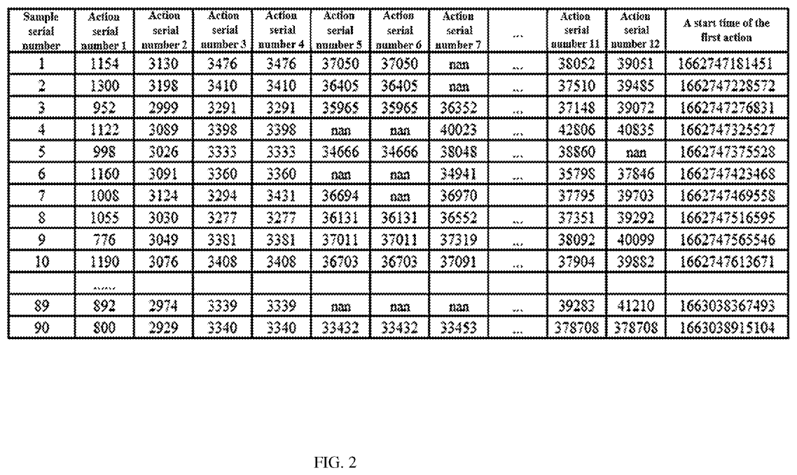

FIG. 2 exemplarily shows partial data of a duration (in milliseconds) of each action (action serial number 1 to 12) performed at station serial number 1 of line body serial number 1 in a production process of vehicle type number 100 with respect to the first action.

S104, performing two-dimensional matrix conversion on the first dataset to obtain a first matrix when there is a missing value in the first dataset.

Specifically, it may cause data to be missing at some time points if errors or omissions occur in an actual data collection and transmission process, further causing a missing value to exist in the first dataset.

In a case of data missing, the accuracy of process cycle time calculation has certain limitations. Therefore, a two-dimensional matrix conversion may be performed on the first dataset to fill the missing value in the first dataset.

Taking the first dataset shown in FIG. 2 as an example, a position of the missing data is marked as nan, and the cell indicates that the corresponding data is missing.

S106, performing filling on the missing value in the first matrix by using the K-nearest neighbors model and the chain equation model of random forest to obtain a corresponding filling value.

Exemplarily, the filling value may be a value obtained based on existing values in the matrix, and used to fill the missing data. Taking the first dataset shown in FIG. 2 as an example, for a position marked as nan in the first dataset, a value of the corresponding position in the first matrix is null, and the filling value may be the value obtained after calculation for a position where a null value is in the first matrix. For example, the filling value may represent the duration of the action or the start time of the first action, which were omitted during the data collection and transmission process.

S108, filling the filling value in the position of the corresponding missing value in the first dataset to obtain a second dataset.

Exemplarily, a cell represented as nan in the first dataset is represented as a corresponding filling value in the second dataset.

Optionally, the filling value may be filled in the first matrix to obtain the second matrix, and then the second matrix may be converted to a second dataset.

S110, determining a process cycle time of the target station of the target line body in the production process of the target vehicle type based on the second dataset.

Specifically, the second dataset is a dataset obtained after filling the missing value completely. That is, in the second dataset, the duration data of each action performed at the target station of the target line body in the production process of the target vehicle type with respect to the first action are not missing. Based on the complete duration of each action performed at the target station of the target line body in the production process of the target vehicle type with respect to the first action, the process cycle time of the target station of the target line body in the production process of the target vehicle type may be determined.

In the above process cycle time determination method, performing processing to obtain the first dataset based on production process data and the attribute data of the line body of the production line, where the first dataset includes the duration of each action performed at the target station of the target line body in the production process of the target vehicle type with respect to the first action; performing two-dimensional matrix conversion on the first dataset to obtain the first matrix when there is the missing value in the first dataset; using the K-nearest neighbors model and the chain equation model of random forest to perform filling on the missing value in the first matrix to obtain the corresponding filling value; then filling the filling value in the position of the corresponding missing value in first dataset to obtain the second dataset; and determining the process cycle time of the target station of the target line body in the production process of the target vehicle type based on the second dataset. By integrating the production process data with the attribute data of the line body of the production line, a time-series dataset of each action performed at different stations of different line bodies is constructed, which can provide support for subsequent missing data filling, so that the missing value can be better filled, thereby improving the accuracy of process cycle time calculation result.

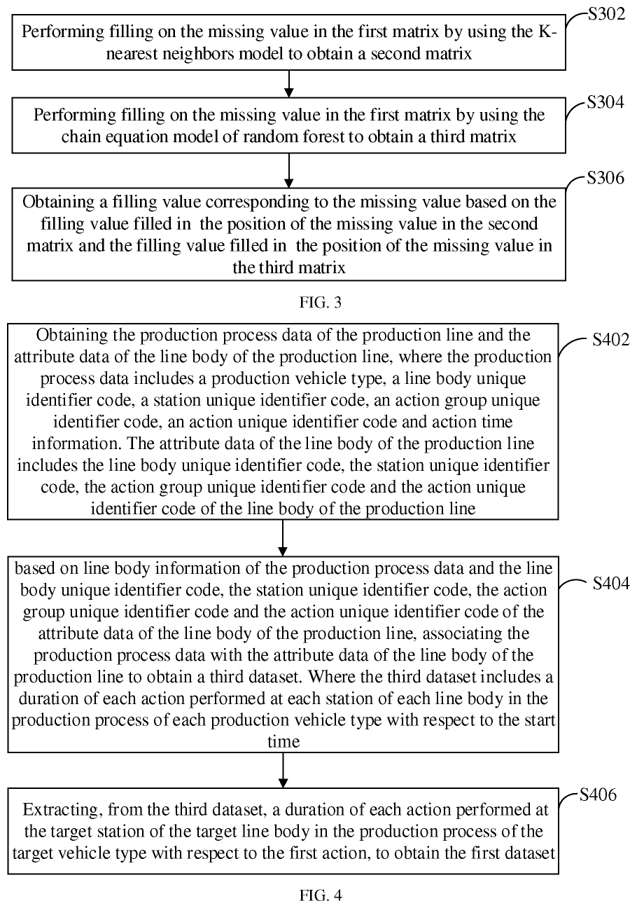

In one of the embodiments, as shown in FIG. 3, perform filling on the missing value in the first matrix by using the K-nearest neighbors model and the chain equation model of random forest to obtain a corresponding filling value, including:

S302, performing filling on the missing value in the first matrix by using the K-nearest neighbors model to obtain a second matrix.

Specifically, based on a preset number of adjacent samples used to fill the missing value, perform filling on the missing value in the first matrix Y by using the K-nearest neighbors model to obtain the second matrix determined by the K-nearest neighbors model. For example, the second matrix may be referred to as a filling matrix Y_1. Where, the value, at a corresponding position in the filling matrix Y_1, of the missing value in the first matrix Y may be a first filling value of the missing value. For example, the number of adjacent samples may be 5. The value of the adjacent samples is not limited to the embodiments of the present application.

S304, performing filling on the missing value in the first matrix by using the chain equation model of random forest to obtain a third matrix.

Specifically, take all action columns and start time columns of the first action of the basic matrix Y as feature columns, new added column as a category column, and construct a chain equation model of random forest to perform filling on the missing data in the feature columns of the basic matrix Y to obtain the third matrix. For example, the third matrix may be referred to as a filling matrix Y_2. Where, the value, at a corresponding position in the filling matrix Y_2, of the missing value in the first matrix Y may be a second filling value of the missing value.

S306, obtaining a filling value corresponding to the missing value based on the filling value filled in the position of the missing value in the second matrix and the filling value filled in the position of the missing value in the third matrix.

Specifically, based on a preset condition, the filling value corresponding to the missing value may be obtained according to the first filling value and the second filling value.

The process cycle time determination method provided in the embodiments of the present application calculates the filling value corresponding to the missing value by using both the K-nearest neighbors model and the chain equation model of random forest, thereby improving the accuracy of the calculation of the filling value.

In one of the embodiments, obtaining the filling value corresponding to the missing value based on the filling value filled in the position of the missing value in the second matrix and the filling value filled in the position of the missing value in the third matrix may include:

Performing weighted summation on the filling value filled in the position of the missing value in the second matrix and the filling value filled in the position of the missing value in the third matrix to obtain the filling value corresponding to the missing value.

Exemplarily, performing weighted summation on the filling value obtained by the two methods to obtain the final filling value. For example, the filling value=the first filling value*a+the second filling value*b, where a is a weight coefficient corresponding to the first filling value, b is a weight coefficient corresponding to the second filling value, and a+b=1.

The process cycle time determination method provided in the embodiments of the present application calculates the filling value corresponding to the missing value by using both the K-nearest neighbors model and the chain equation model of random forest, and then perform weighted summation on the filling value calculated according to the two methods to obtain the final filling value, which not only consider data characteristics of the adjacent positions of the missing data, but also consider nonlinear association relationship between actions, so that the missing value can be better filled.

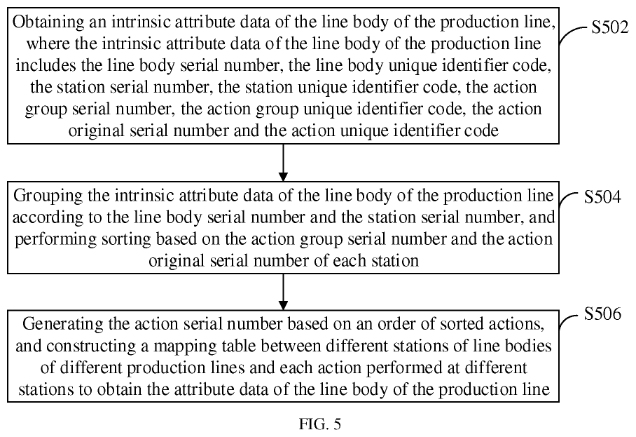

In one of the embodiments, as shown in FIG. 4, performing processing to obtain a first dataset based on production process data and attribute data of the line body of the production line may include the following steps:

S402, obtaining the production process data of the production line and the attribute data of the line body of the production line, where the production process data includes a production vehicle type, a line body unique identifier code, a station unique identifier code, an action group unique identifier code, an action unique identifier code and action time information. The attribute data of the line body of the production line includes the line body unique identifier code, the station unique identifier code, the action group unique identifier code and the action unique identifier code of the line body of the production line.

Exemplarily, the production process data and the attribute data of the line body of the production line may be obtained by a production line data service platform. In a specific application scenario, the production process data and the attribute data of the line body of the production line may be collected through an intelligent manufacturing data service platform built by enterprise itself.

S404, based on line body information of the production process data and the line body unique identifier code, the station unique identifier code, the action group unique identifier code and the action unique identifier code of the attribute data of the line body of the production line, associating the production process data with the attribute data of the line body of the production line to obtain a third dataset. Where the third dataset includes a duration of each action performed at each station of each line body in the production process of each production vehicle type with respect to the start time.

Exemplarily, the attribute data of the line body of the production line includes line body serial number Lᵢ and line body unique identifier code LNᵢ, station serial number LP_{i,j} and station unique identifier code LPN_{i,j}, action group serial number PE_{i,j,k} and action group identifier code PEN_{i,j,k}, action serial number EX_{i,j,k,m} and action unique identifier code EXN_{i,i,k,m} attribute data, where Lᵢ represents the iₜₕ line body, i=1,2 . . . . N, LP_{i,j} represents the jₜₕ station of the iₜₕ line body, j=1,2 . . . . SN, PE_{i,j,k} represents the kth action group of the jₜₕ station of the iₜₕ line body, k=1,2 . . . . SK, and EX_{i,j,k,m} represents the mₜₕ action of the kth action group of the jₜₕ station of the iₜₕ line body, m=1,2 . . . . SM.

Production process data includes different vehicle types C, line body unique identifier code LNᵢ, station unique identifier code LPN_{i,j}, action group identifier code PEN_{i,j,k}, action unique identifier code EXN_{i,j,k,m} flag F of the first action of the station (F=1 represents the first action), the start time EST_{i,j,k,m} of the action, the end time EEN_{i,j,k,m} of the action, duration ETL_{i,j,k,m} of the action, where ETL_{i,i,k,m}=EEN_{i,j,k,m}−EST_{i,j,k,m}.

Where, the line body unique identifier code, the station unique identifier code, the action group identifier code and the action unique identifier code exist in both the attribute data of the line body of the production line and the production process data. An integrated dataset may be obtained by associating the attribute data of the line body of the production line and the production process data through the above unique identifier codes, that is, the third dataset. Where i represents the iₜₕ line body, j represents the jₜₕ station, p represents the pₜₕ action, q represents vehicle type, and dₛₜ represents a duration of the pₜₕ action with respect to the starting the time st.

S406, extracting, from the third dataset, a duration of each action performed at the target station of the target line body in the production process of the target vehicle type with respect to the first action, to obtain the first dataset.

Specifically, the third dataset includes a duration of a plurality of production actions performed at a plurality of stations of a plurality of line bodies in production processes of a plurality of vehicle types with respect to the first action, and may also include the start time of the first action. Where, the process cycle time is determined for each production action performed at the target station of the target line body in the production process of the target vehicle type, therefore the first dataset required to determine the process cycle time may be extracted from the third dataset.

Exemplarily, extracting a duration of line body i, station j and action p in production process of vehicle type q with respect to the first action from dataset X_{i,j,p,g,d}_{ₛₜ} to obtain dataset D_{Q,R} (i.e., the first dataset). Where, Q represents a number of times that flag F=1 of the first action occurs, and a time difference between adjacent first actions is greater than alpha, which is a number of cycle in a certain period.

R=r₁+r₂+r₃, where r₁ represents a total number of actions of the jₜₕ station of the iₜₕ line body, r₂ represents column of the start time of the first action, r₃ represents column of the end time of the last action, d_{x,p} represents a duration of the pₜₕ action in the xₜₕ cycle with respect to the first action, d_{x,R} represents the start time of the first action and the end time of the last action in the xₜₕ cycle, where alpha is an adjustable parameter.

According to the process cycle time determination method provided in embodiments of the present application, integrating the production process data with the attribute data of the line body of the production line based on unique identifier codes, which can accurately construct a time sequence dataset of different actions in different stations of different line bodies, so as to provide support for subsequent missing data filling.

In one of the embodiments, the attribute data of the line body of the production line further includes a line body serial number, a station serial number, an action group serial number and an action serial number.

As shown in FIG. 5, obtaining the attribute data of the line body of the production line may include the following steps:

S502, obtaining an intrinsic attribute data of the line body of the production line, where the intrinsic attribute data of the line body of the production line includes the line body serial number, the line body unique identifier code, the station serial number, the station unique identifier code, the action group serial number, the action group unique identifier code, the action original serial number and the action unique identifier code.

Where, the intrinsic attribute data may be data such as numbers, serial numbers and identifier codes for line bodies, stations, action groups and actions. For example, the intrinsic attribute data may be obtained through data platforms such as production line data service platform or intelligent manufacturing data service platform built by enterprise itself.

S504, grouping the intrinsic attribute data of the line body of the production line according to the line body serial number and the station serial number, and performing sorting based on the action group serial number and the action original serial number of each station.

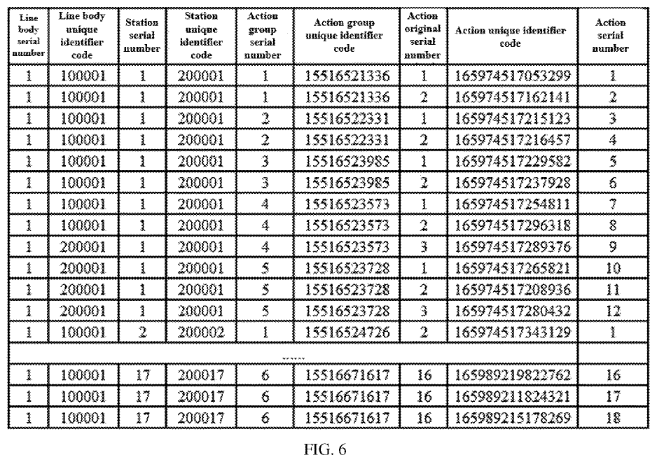

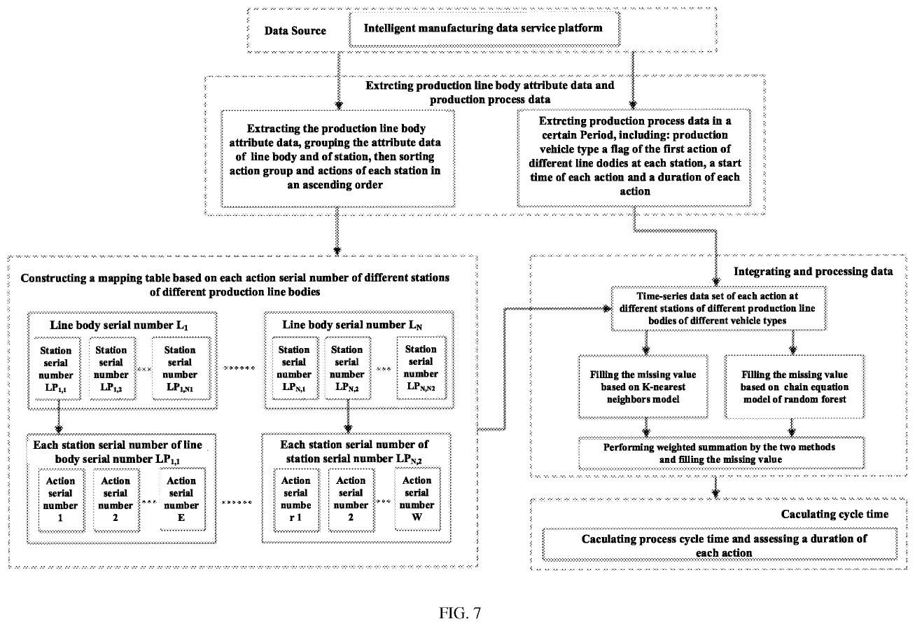

In a specific application scenario, as shown in FIG. 6, the intrinsic attribute data of the line body of the production line with line body serial number 1 is grouped and sorted. For example, the action group serial number and the action serial number of each station are sequentially sorted in ascending order to obtain an arrangement order as shown in FIG. 6.

S506, generating the action serial number based on an order of sorted actions, and constructing a mapping table between different stations of line bodies of different production lines and each action performed at different stations to obtain the attribute data of the line body of the production line.

Specifically, in the intrinsic attribute data of the line body of the production line illustrated in FIG. 6, new action serial numbers are sequentially generated based on an action order obtained by sorting the action group serial numbers and the action serial numbers of each station in ascending order, and a mapping table between different stations of line bodies of different production lines and each action performed at different stations is constructed to obtain the attribute data of the line body of the production line.

In the process cycle time determination method provided in embodiments of the present application, by constructing attribute codes and the mapping table of each action performed at different stations of different line bodies, which can provide an accurate basis for association and integration of the production process data and the attribute data of the line body of the production line.

In one of the embodiments, the process cycle time includes an actual station cycle time of the target station, a station production cycle time of the target station, the start time of each action, the end time of each action and a duration of each action. Where, the actual station cycle time is the maximum duration of the last action of the target station with respect to the first action of the target station, and the station production cycle time is a difference between the start time of first action performed at the target station and the start time of the first action performed at the next station.

For example, calculating the station production cycle time JPPₓ corresponding to the xₜₕ cycle can be expressed as:

$${JPP}_{x} = {d}_{x + 1 , {r}_{2}} - {d}_{x , {r}_{2}}$$

calculating the actual station cycle time JPAₓ can be expressed as:

$${JPA}_{x} = {d}_{x , {r}_{3}} - {d}_{x , {r}_{2}}$$

max(d_{x,p}) represents a duration of the last action with respect to the first action in the xₜₕ cycle. Where, d_{x,p} represents the duration of the pₜₕ action with respect to the first action in the xₜₕ cycle, d_{x,R} represents the start time of the first action and the end time of the last action in the xₜₕ cycle.

To further explain the solutions in embodiments of the present application, the following illustrates the solutions with reference to a specific example. Taking the method applied to attribute data of a line body of a production line and production process data extracted from an intelligent manufacturing data service platform as an example, as shown in FIG. 7, the method includes the following steps:
Step 1: Extracting serial numbers of line bodies, stations, action groups and actions, and unique identifier codes of line bodies, stations, action groups and actions from the intelligent manufacturing data service platform.
Step 2: Extracting the dataset with line body serial number 1, grouping the attribute data according to line body serial number and station serial number, then sorting action group serial numbers and action serial numbers of each station in an ascending order, further generating new serial numbers between different stations and each action of the different stations, and then constructing a mapping table of different line bodies, different stations and each action of the different stations to obtain the mapping table as shown in FIG. 6.
Step 3: Numbering the vehicle type extracted from a period of 2022 Sep. 10 00:00:00 to 2022 Sep. 17 00:00:00 as 100. Taking production process data of each action of line body serial number 1 and line body unique identifier code 100001, station serial number 1 and station unique identifier code 200001 as an example, the production process data includes a flag of the first action of the station, the start time of each action, the end time of each action and a duration (milliseconds) of each action with respect to the first action. Where, the duration of each action with respect to the first action=the start time of the first action of the station+ (the end time of each action−the start time of each action);
Step 4: Associating data obtained from Step 2 with data obtained from Step 3 by the line body serial number and the line body unique identifier code to obtain an integrated dataset X.
Step 5: Extracting a duration of 12 actions with respect to the first action of line body serial number 1 and station serial number 1 in a production of vehicle type number 100 from dataset X as dataset D. For example, partial data of the duration (in milliseconds) of each action of line body serial number 1 and station serial number 1 in the production of the vehicle type number 100 with respect to the first action as shown in the dataset in FIG. 2. Where, the start time of the first action shown in FIG. 2 is Linux time, which means that it is calculated from the start time of Jan. 1, 1970, 00:00:00, in milliseconds. For example, the start time of the first action with sample serial number 1 is 1662747181451, which refers to the time calculated from the start time of Jan. 1, 1970, 00:00:00, after 1662747181451 milliseconds, corresponding to the windows time of Sep. 10, 2022, 02:13:01. The duration of action serial number 1 with respect to the first action of sample serial number 1 is 1154, which indicates that the action serial number 1 ended after 1154 milliseconds starting from 1662747181451. The units and formats of time data are not limited to the embodiments of the present application.
Step 6: Obtaining the number of rows G=16 where the missing value exists in dataset D.
Step 7: Obtaining a basic matrix Y based on dataset D, where values of each element of the basic matrix Y are corresponding values in the dataset D, and the position of the missing data is marked as nan.
Step 8: Setting a number of adjacent samples used to fill the missing value to 5, and constructing the K-nearest neighbors model to fill the missing data in dataset D to obtain a filled matrix Y_1.
Step 9: Taking all action columns and the start time columns of the first action in dataset D as feature columns, adding a new column as a category column, and constructing the chain equation model of random forest to fill the missing data in the feature columns of dataset D to obtain a filled matrix Y_2.
Step 10: Performing weighted summation on the filling values obtained by the two models. For example, if the filling values in the two models for filling action serial number 12 and sample serial number 5 (the 5th cycle) respectively are 39246 and 38970, and a final filling value is 39246×0.5+38970×0.5=39108.
Step 11: Obtaining the maximum duration of each action with respect to the first action during the 5th cycle, which is 39108 milliseconds after filling, and also is an actual station cycle time 39108/1000=39.108 seconds; calculating an station production cycle time (1662747423468−1662747375528)/1000=47.94 seconds; and analogizing in turn to obtain a duration of each action of missing positions with respect to the first action, and the actual station cycle time and station production cycle time during each cycle.

According to the process cycle time determination method provided in embodiments of the present application, attribute information of each action of different stations of different line bodies can be effectively encoded, and a mapping table is constructed. By integrating the attribute information with the production process data, a time-series dataset of each action performed at different stations of different line bodies is constructed, which can provide support for subsequent missing data filling. Meanwhile, the K-nearest neighbors model and the chain equation model of random forest are both used, which not only consider data characteristics of the adjacent positions of the missing data, but also consider nonlinear association relationship between actions, so that the missing value can be better filled.

It should be understood that, although the steps in the flowchart related to the embodiments described above are sequentially displayed according to the direction of arrows, these steps are not necessarily executed in the order indicated by the arrows. Unless explicitly stated herein, the execution of these steps is not strictly limited in sequence, and these steps can be executed in other orders. Moreover, at least some of the steps in the flowchart involved in the embodiments described above may include a plurality of steps or a plurality of stages, these steps or stages are not necessarily executed at the same time, but may be executed at different times. The execution order of these steps or stages is not necessarily executed sequentially, but may be performed in turn or alternately with other steps or at least part of the steps or stages in other steps.

Based on the same inventive concept, an embodiment of the present application further provides a process cycle time determination apparatus 800 used to implement the process cycle time determination method mentioned above. A solution provided in the apparatus 800 is similar to a solution described in the above method. Therefore, the specific limitations in one or more embodiments of the process cycle time determination apparatus 800 provided below may be seen the limitations of the process cycle time determination method above, and are not described herein again.

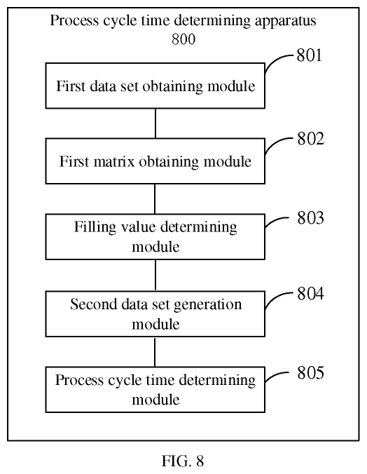

In an embodiment, as shown in FIG. 8, a process cycle time determination apparatus 800 is provided. In the embodiment, the process cycle time determination apparatus 800 includes: a processor, where the processor is configured to execute the following program modules stored in a memory:
a first dataset obtaining module 801, configured to perform processing to obtain a first dataset based on production process data and attribute data of a line body of a production line, where the first dataset includes a duration of each action performed at a target station of a target line body in a production process of a target vehicle type with respect to the first action;
a first matrix obtaining module 802, configured to perform two-dimensional matrix conversion on the first dataset to obtain a first matrix when there is a missing value in the first dataset;
a filling value determining module 803, configured to perform filling on the missing value in the first matrix by using the K-nearest neighbors model and the chain equation model of random forest to obtain a corresponding filling value;
a second dataset generation module 804, configured to fill the filling value in the position of the corresponding missing value in the first dataset to obtain a second dataset; and
a process cycle time determining module 805, configured to determine a process cycle time of the target station of the target line body and in the production process of the target vehicle type based on the second dataset.

In an embodiment, the filling value determining module 803 includes:
a second matrix determining unit, configured to perform filling on the missing value in the first matrix by using the K-nearest neighbors model to obtain a second matrix;
a third matrix determining unit, configured to perform filling on the missing value in the first matrix by using the chain equation model of random forest to obtain a third matrix;
a filling value determining unit, configured to obtain a filling value corresponding to the missing value in the first matrix based on the filling value filled in the position of the missing value in the second matrix and the filling value filled in the position of the missing value in the third matrix.

In an embodiment, the filling value determining unit includes:
a weighted summation subunit, configured to perform weighted summation on the filling value filled in the position of the missing value in the second matrix and the filling value filled in the position of the missing value in the third matrix to obtain the filling value corresponding to the missing value in the first matrix.

In an embodiment, the first dataset obtaining module 801 includes:
a production process data and attribute data of the line body of the production line obtaining unit, configured to obtain the production process data of the production line and the attribute data of the line body of the production line, where the production process data includes a production vehicle type, a line body unique identifier code, a station unique identifier code, an action group unique identifier code, an action unique identifier code and action time information, and the attribute data of the line body of the production line includes the line body unique identifier code, the station unique identifier code, the action group unique identifier code and the action unique identifier code of the line body of the production line;
a data association unit, configured to based on line body information of the production process data and the line body unique identifier code, the station unique identifier code, the action group unique identifier code and the action unique identifier code of the attribute data of the line body of the production line, associate the production process data with the attribute data of the line body of the production line to obtain a third dataset, where the third dataset includes a duration of each action performed at each station of each line body in the production process of each vehicle type with respect to the start time;
a data extraction unit, configured to extract, from the third dataset, a duration of each action performed at the target station of the target line body in the production process of the target vehicle type with respect to the first action, to obtain the first dataset.

In one of the embodiments, the attribute data of the line body of the production line also includes a line body serial number, a station serial number, an action group serial number and an action serial number.

The production process data and attribute data of the line body of the production line obtaining unit include:
an intrinsic attribute data obtaining subunit, configured to obtain an intrinsic attribute data of the line body of the production line, where the intrinsic attribute data of the line body of the production line, where the intrinsic attribute data of the line body of the production line includes the line body serial number, the line body unique identifier code, the station serial number, the station unique identifier code, the action group unique identifier code, an action original serial number and the action unique identifier code;
a data sorting subunit, configured to group the intrinsic attribute data of the line body of the production line according to the line body serial number and the station serial number, and perform sorting for the intrinsic attribute data of the line body of the production line based on the action group serial number and the action original serial number of each station; and
an action serial number determining subunit, configured to generate the action serial number based on an order of sorted actions, and construct a mapping table between different stations and each action and each action of the different stations of line bodies of different production lines and each action performed at different stations to obtain the attribute data of the line body of the production line.

In one of the embodiments, the process cycle time includes a station actual cycle time of the target station, a station production cycle time of the target station, the start time of each action, the end time of each action and a duration of each action, wherein the station actual cycle time is the maximum duration of the last action of the target station with respect to the first action of the target station, and the station production cycle time is a difference between the start time of the first action of the target station and the start time of the first action of next station.

Each module of the above process cycle time determination apparatus 800 may be implemented in whole or in part through software, hardware or a combination thereof. Each of the above modules may be embedded in or independent of a processor in a computer device in hardware form, or stored in memory in the computer device in software form, so that the processor invokes and executes operations corresponding to each module.

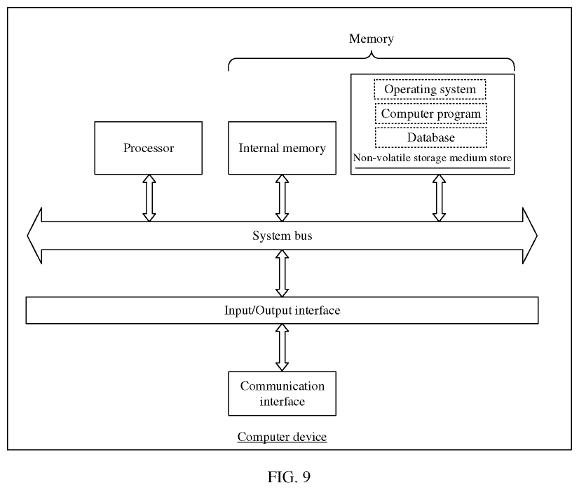

In an embodiment, a computer device is provided, where the computer device may be a server, and an internal structure diagram thereof as shown in FIG. 9. The computer device includes a processor, a memory, an input/output interface (I/O) and a communication interface. Where, the processor, the memory and the input/output interface are connected through a system bus, the communication interface is connected to the system bus through the input/output interface. The processor of the computer device is used to provide computing and control capabilities. The memory of the computer device includes a non-volatile storage medium and an internal memory, the non-volatile storage medium stores an operating system, a computer program and a database, where the internal memory provides an environment for an operation of the operating system and the computer program in non-volatile storage medium, the database of the computer device is used to store process cycle time determining data. The input/output interface of the computer device is used to exchange information between the processor and external devices. The communication interface of the computer device is used to communicate with external terminals through network connections, and the computer program is executed by the processor to implement the process cycle time determination method.

A person skilled in the art should understand that the structure shown in FIG. 9 is merely a block diagram of part of the structure related to the solution of the present application, and does not constitute a limitation on the computer device to which the solution of the present application is applied. The specific computer device may include more or fewer components than those shown in the FIG. 9, or combine partial components, or have different component arrangements. In an embodiment, a computer device is provided, including a memory and a processor, where the memory stores a computer program, and the steps of the above method are implemented when the computer program is executed by the processor.

In an embodiment, a computer-readable storage medium is provided, on which computer program is stored, and the computer program implements the steps of the above method when executed by a processor.

In an embodiment, a computer program product is provided in an embodiment, including a computer program, and the computer program implements the steps of the above method when executed by a processor.

A person skilled in the art should understand that the entire or part of the process in the method of the above embodiments may be implemented by instructing related hardware through a computer program. The computer program may be stored in a non-volatile computer-readable storage medium, and when the computer program is executed, it may include the process of embodiment described in the above methods. Any reference to the memory, the database or other media used in embodiments provided in the present application may include at least one of the non-volatile memory and the volatile memory. The non-volatile memory may include read-only memory (ROM), magnetic tape, floppy disk, flash memory, optical memory, high-density embedded non-volatile memory, resistive memory (ReRAM), magnetoresistive random access memory (MRAM), ferroelectric random access memory (FRAM), phase change memory (PCM), graphene memory, etc. The volatile memory may include random access memory (RAM) or external high-speed cache memory, etc. As an illustration, but not limited to, RAM may be in various forms, such as static random access memory (SRAM) or dynamic random access memory (DRAM), etc. The database involved in embodiments of the present application may include at least one of a relational database and a non-relational database. The non-relational database may include, but is not limited to blockchain-based distributed database, etc. The processor involved in embodiments of the present application may be, a general-purpose processor, a central processor, a graphics processor, a digital signal processor, a programmable logic device and a quantum computing-based data processing logic device, etc., but is not limited thereto.

The technical features of the above embodiments may be arbitrarily combined. To keep the description concise, not all possible combinations of the technical features in the above embodiments have been described. However, as long as the combination of these technical features does not conflict, it should be considered within the scope of the specification described herein.

The above-mentioned embodiments merely express several embodiments of the present application, and the description is relatively specific and detailed, but it should not be understood as a limitation to the patent scope of the present application. It should be noted that a person skilled in the art may make several modifications and improvements without departing from the concept of the present application, all of which shall fall within the protection scope of the present application. Therefore, the protection scope of the present application shall be subject to the attached claims.

What is claimed is:

1. A process cycle time determination method, comprising:
performing processing to obtain a first dataset based on production process data and attribute data of a line body of a production line, wherein the first dataset comprises a duration of each action performed at a target station of a target line body in a production process of a target vehicle type with respect to the first action;
performing two-dimensional matrix conversion on the first dataset to obtain a first matrix when there is a missing value in the first dataset;
performing filling on the missing value in the first matrix by using the K-nearest neighbors model and the chain equation model of random forest to obtain a corresponding filling value;
filling the filling value in the position of the corresponding missing value in the first dataset to obtain a second dataset; and
determining a process cycle time of the target station of the target line body in the production process of the target vehicle type based on the second dataset.

2. The process cycle time determination method according to claim 1, wherein the performing filling on the missing value in the first matrix by using the K-nearest neighbors model and the chain equation model of random forest to obtain a corresponding filling value comprises:
performing filling on the missing value in the first matrix by using the K-nearest neighbors model to obtain a second matrix;
performing filling on the missing value in the first matrix by using the chain equation model of random forest to obtain a third matrix; and
obtaining a filling value corresponding to the missing value in the first matrix based on the filling value filled in the position of the missing value in the second matrix and the filling value filled in the position of the missing value in the third matrix.

3. The process cycle time determination method according to claim 2, wherein the performing filling on the missing value in the first matrix by using the K-nearest neighbors model to obtain a second matrix comprises:
based on a preset number of adjacent samples used to fill the missing value, performing filling on the missing value in the first matrix by using the K-nearest neighbors model to obtain the second matrix.

4. The process cycle time determination method according to claim 2, wherein the performing filling on the missing value in the first matrix by using the chain equation model of random forest to obtain a third matrix comprises:
taking all action columns and start time columns of the first action of the first matrix as feature columns, and constructing a chain equation model of random forest to perform filling on the missing data in the feature columns of the first matrix to obtain the third matrix.

5. The process cycle time determination method according to claim 2, wherein the obtaining a filling value corresponding to the missing value in the first matrix based on the filling value filled in the position of the missing value in the second matrix and the filling value filled in the position of the missing value in the third matrix comprises:
performing weighted summation on the filling value filled in the position of the missing value in the second matrix and the filling value filled in the position of the missing value in the third matrix to obtain the filling value corresponding to the missing value in the first matrix.

6. The process cycle time determination method according to claim 1, wherein the performing processing to obtain a first dataset based on production process data and attribute data of a line body of a production line comprises:
obtaining the production process data of the production line and the attribute data of the line body of the production line, wherein the production process data comprises a production vehicle type, a line body unique identifier code, a station unique identifier code, an action group unique identifier code, an action unique identifier code and action time information, and the attribute data of the line body of the production line comprises the line body unique identifier code, the station unique identifier code, the action group unique identifier code and the action unique identifier code of the line body of the production line;
based on line body information of the production process data and the line body unique identifier code, the station unique identifier code, the action group unique identifier code and the action unique identifier code of the attribute data of the line body of the production line, associating the production process data with the attribute data of the line body of the production line to obtain a third dataset, wherein the third dataset comprises a duration of each action performed at each station of each line body in the production process of each vehicle type with respect to the start time; and
extracting, from the third dataset, a duration of each action performed at the target station of the target line body in the production process of the target vehicle type with respect to the first action, to obtain the first dataset.

7. The process cycle time determination method according to claim 6, wherein the attribute data of the line body of the production line further comprises a line body serial number, a station serial number, an action group serial number and an action serial number,
the obtaining attribute data of the line body of the production line body comprises:
obtaining an intrinsic attribute data of the line body of the production line, wherein the intrinsic attribute data of the line body of the production line comprises the line body serial number, the line body unique identifier code, the station serial number, the station unique identifier code, the action group serial number, the action group unique identifier code, an action original serial number and the action unique identifier code.

8. The process cycle time determination method according to claim 7, wherein the obtaining attribute data of the line body of the production line body further comprises:
grouping the intrinsic attribute data of the line body of the production line according to the line body serial number and the station serial number, and performing sorting for the intrinsic attribute data of the line body of the production line based on the action group serial number and the action original serial number of each station; and
generating the action serial number based on an order of sorted actions, and constructing a mapping table between different stations of line bodies of different production lines and each action performed at different stations to obtain the attribute data of the line body of the production line.

9. The process cycle time determination method according to claim 1, wherein the process cycle time comprises a station actual cycle time of the target station, a station production cycle time of the target station, the start time of each action, the end time of each action and a duration of each action, wherein the station actual cycle time is the maximum duration of the last action of the target station with respect to the first action of the target station, and the station production cycle time is a difference between the start time of the first action of the target station and the start time of the first action of next station.

10. The process cycle time determination method according to claim 9, wherein the station production cycle time JPPₓ is calculated by the following formula:
$${JPP}_{x} = {d}_{x + 1 , {r}_{2}} - {d}_{x , {r}_{2}}$$
wherein d_{x,r}_{₂} represents the start time of the first action in the xₜₕ cycle.

11. The process cycle time determination method according to claim 9, wherein the actual station cycle time JPAₓ is calculated by the following formula:
$${JPA}_{x} = {d}_{x , {r}_{3}} - {d}_{x , {r}_{2}}$$
wherein d_{x,r}_{₂} represents the start time of the first action in the xₜₕ cycle, d_{x,r}_{₃} represents the end time of the first action in the xₜₕ cycle.

12. A computer device, comprising: a memory and a processor, wherein the memory stores a computer program, and when the computer program is executed, the processor is configured to:
perform processing to obtain a first dataset based on production process data and attribute data of a line body of a production line, wherein the first dataset comprises a duration of each action performed at a target station of a target line body in a production process of a target vehicle type with respect to the first action;
perform two-dimensional matrix conversion on the first dataset to obtain a first matrix when there is a missing value in the first dataset;
perform filling on the missing value in the first matrix by using the K-nearest neighbors model and the chain equation model of random forest to obtain a corresponding filling value;
fill the filling value in the position of the corresponding missing value in the first dataset to obtain a second dataset; and
determine a process cycle time of the target station of the target line body in the production process of the target vehicle type based on the second dataset.

13. The computer device according to claim 12, wherein the processor is further configured to:
perform filling on the missing value in the first matrix by using the K-nearest neighbors model to obtain a second matrix;
perform filling on the missing value in the first matrix by using the chain equation model of random forest to obtain a third matrix; and
obtain a filling value corresponding to the missing value in the first matrix based on the filling value filled in the position of the missing value in the second matrix and the filling value filled in the position of the missing value in the third matrix.

14. The computer device according to claim 13, wherein the processor is further configured to:
take all action columns and start time columns of the first action of the first matrix as feature columns, and construct a chain equation model of random forest to perform filling on the missing data in the feature columns of the first matrix to obtain the third matrix.

15. The computer device according to claim 13, wherein the processor is further configured to:
perform weighted summation on the filling value filled in the position of the missing value in the second matrix and the filling value filled in the position of the missing value in the third matrix to obtain the filling value corresponding to the missing value in the first matrix.

16. The computer device according to claim 12, wherein the processor is further configured to:
obtain the production process data of the production line and the attribute data of the line body of the production line, wherein the production process data comprises a production vehicle type, a line body unique identifier code, a station unique identifier code, an action group unique identifier code, an action unique identifier code and action time information, and the attribute data of the line body of the production line comprises the line body unique identifier code, the station unique identifier code, the action group unique identifier code and the action unique identifier code of the line body of the production line;
based on line body information of the production process data and the line body unique identifier code, the station unique identifier code, the action group unique identifier code and the action unique identifier code of the attribute data of the line body of the production line, associate the production process data with the attribute data of the line body of the production line to obtain a third dataset, wherein the third dataset comprises a duration of each action performed at each station of each line body in the production process of each vehicle type with respect to the start time; and
extract, from the third dataset, a duration of each action performed at the target station of the target line body in the production process of the target vehicle type with respect to the first action, to obtain the first dataset.

17. The computer device according to claim 16, wherein the processor is further configured to:
obtain an intrinsic attribute data of the line body of the production line, wherein the intrinsic attribute data of the line body of the production line comprises the line body serial number, the line body unique identifier code, the station serial number, the station unique identifier code, the action group serial number, the action group unique identifier code, an action original serial number and the action unique identifier code.

18. The computer device according to claim 17, wherein the processor is further configured to:
group the intrinsic attribute data of the line body of the production line according to the line body serial number and the station serial number, and perform sorting for the intrinsic attribute data of the line body of the production line based on the action group serial number and the action original serial number of each station; and
generate the action serial number based on an order of sorted actions, and construct a mapping table between different stations of line bodies of different production lines and each action performed at different stations to obtain the attribute data of the line body of the production line.

19. The computer device according to claim 12, wherein the process cycle time comprises a station actual cycle time of the target station, a station production cycle time of the target station, the start time of each action, the end time of each action and a duration of each action, wherein the station actual cycle time is the maximum duration of the last action of the target station with respect to the first action of the target station, and the station production cycle time is a difference between the start time of the first action of the target station and the start time of the first action of next station.

20. A non-transitory computer-readable storage medium, on which a computer program is stored, wherein the computer program implements the steps of the process cycle time determination method according to claim 1 when executed by a processor.
